(19) United States
(12) Patent Application Publication
(10) Pub. No.: US 2023/0160634 A1
(43) Pub. Date: May 25, 2023

(54) CRYOGENIC PROCESS FOR SEPARATION OF CO2 FROM A HYDROCARBON STREAM

(71) Applicant: L'Air Liquide, Societe Anonyme pour l'Etude et l’Exploitation des Procedes Georges Claude, Paris (FR)

(72) Inventors: Sandeep KARODE, Boothwyn, PA (US); Sudhir KULKARNI, Wilmington, DE (US); Paul TERRIEN, Syracuse, NY (US)

(73) Assignee: L'Air Liquide, Societe Anonyme pour l'Etude et l?Exploitation des Procedes Georges Claude, Paris (FR)

(21) Appl. No.: 17/534,198

(22) Filed: Nov. 23, 2021

(51) Int. Cl. F25J 3/02

(52) U.S. Cl. CPC F25J 3/0266; F25J 3/0209; F25J 2205/80; F25J 2220/82; F25J 2230/60; F25J 2245/02; F25J 2240/02; F25J 2205/40; F25J 2230/30; F25J 2215/04

(57) ABSTRACT

A pressurized CO₂ rich gas is cooled down to condense at least part of the stream in a heat exchanger. A bulk of the CO₂ is separated by partial condensation and distillation in order to obtain at least one non-condensable gas from a separation vessel. The non-condensable gas is optionally heated up to a temperature lower than −20° C. (membranes performances is greatly enhanced by low temperature operation). The non-condensable gas is introduced into a membrane permeation unit, producing a residue stream and a permeate stream (the permeate stream is enriched in CO₂). The permeate stream is recycled to the process, optionally after compression. The method is auto-refrigerated, i. e. no external refrigerant is used to provide cooling below 0° C.

### FIELD OF THE INVENTION

The present invention relates to a process for separation of CO₂ from a hydrocarbon stream, typically from a natural gas with a high CO₂ content.

### BACKGROUND

For natural gas sources with a high CO₂ content, it is necessary to first separate CO₂ from the hydrocarbon stream. Such CO₂ rich natural gas fields exist in different part of the world such as Malaysia with the well-known Natuna field. Recovery of methane from such CO₂ rich stream is more and more important with the traditional natural gas resources becoming scarce.

A traditional natural gas contains typically a few percent of CO₂. However the Natuna field for instance contains more than 70% CO₂. CO₂ removal becomes a must in such cases. In order to minimize the environmental impact, it is often desirable to re-inject the separated CO₂ (either in the same field or in different locations for EOR or simply for long term sequestration). This materializes in specific constraints regarding the CO₂ separated, mainly a minimum pressure to be able to re-inject.

Traditional CO₂ removal techniques include absorption through amines, hot potassium carbonates, and methanol wash. Other options can include a direct treatment of the stream through membranes or through pressure swing adsorption. One of the disadvantages of these techniques is the recovery of CO₂ at low pressure. On top of this, the traditional absorption processes usually consume a lot of regeneration energy in the form of heat—most of the time, steam

However, one particularly efficient technique when dealing with high CO₂ concentration is cryogenics purification. This would essentially consist at least in a partial condensation of the stream under pressure.

However, one inherent issue with partial condensation is the limited recovery achievable. Typically from a natural gas containing 70% CO₂, 90% recovery is achievable with reasonable means but more than 95% is difficult to achieve without unreasonable costs involved (for example, a high pressure compression upstream). This can be challenging when CO₂ specifications in the product natural gas can be 5% or less.

Several have proposed schemes for removal of CO₂ from natural gas, including US 20120291482 A1, U.S. Pat. No. 4,639,257 B1, US 2009/0288556 A1, WO 2012/064941 A1 and WO 2011/084508 A2.

### SUMMARY OF INVENTION

There is disclosed a method for treatment of a pressurized CO₂ rich gas, typically containing CH₄. The method includes at least the following steps: a) the pressurized CO₂ rich gas is cooled down to condense at least part of the stream in a heat exchanger; b) a bulk of the CO₂ is separating by partial condensation and distillation in order to obtain at least one non-condensable gas from a separation vessel; c) the non-condensable gas is optionally heated up to a temperature lower than −20° C. (membranes performances is greatly enhanced by low temperature operation); d) the non-condensable gas is Introduced into a membrane permeation unit, producing a residue stream and a permeate stream (the permeate stream is enriched in CO₂); e) the permeate stream is recycled to the process, optionally after compression; and f) the said method is auto-refrigerated, i. e. no external refrigerant is used to provide cooling below 0° C.

The above-described method may include one or more of the following aspects:
the permeate stream is recycled directly to the distillation of step b).
the permeate stream is recycled directly to the distillation of step b) without compression.
an inlet temperature of the non-condensable gas stream feeding into the membrane permeation unit is below −30° C.
a CO₂/methane selectivity exhibited by a membrane of the membrane permeation unit that is being fed with the non-condensable gas stream at an inlet temperature of below −30° C. is at least twice the CO₂/methane membrane selectivity at 20° C.
the auto-refrigeration is provided by vaporization of a CO₂ enriched bottoms liquid from the distillation of step b), at lower pressure than the feed stream.
the auto-refrigeration is provided by a turbine expansion of the permeate stream and/or the residue stream.
the distillation in step b) includes a reboiling substep and the reboiling energy is provided by an internal stream of the method.
the method further comprises the steps of: g) introducing the permeate stream into a second membrane separation unit to produce a second permeate stream and a second residue stream, and h) delivering the second residue stream as a fuel to a device powered, at least in part, by combustion of the second residue stream.

### BRIEF DESCRIPTION OF DRAWINGS

FIG. 1 is a flow diagram of the CO₂ purification method.

FIG. 2 is a flow diagram of an embodiment of the CO₂ purification method including one alternative additional feature in illustrated in dashed lines.

### DETAILED DESCRIPTION

The present invention proposes a process to operate a CO₂ cryogenic purification unit with a subsequent membrane separation step to increase CO₂ recovery. This hybrid scheme has the efficiency advantage of the cryogenic purification combined with a recovery closer to those of traditional absorption techniques.

In a preferred embodiment, the invention consists in a method for treatment of a pressurized CO₂ rich gas (1), typically containing CH₄, including at least the following steps:
a) Cooling down the pressurized CO₂ rich gas to condense at least part of the stream in a heat exchanger (2);
b) Separating the bulk of the CO₂ by partial condensation (3) and distillation (4) in order to obtain at least one non-condensable gas from a separation vessel;
c) heating up the non-condensable gas (3a, 4a) to a temperature lower than −20° C. (membranes performance is greatly enhanced by low temperature operation);
d) Introducing the non-condensable gas into a membrane permeation unit (5), producing a residue stream (5a) and a permeate stream (5b) (the permeate stream is enriched in CO₂);
e) Recycling the permeate stream to the process (6), optionally after compression (6a); and
f) wherein the method is auto-refrigerated, i. e. no external refrigerant is used to provide cooling below 0° C.

Preferably, the distillation in step b) includes a reboiler and the reboiling energy is provided by heat exchange with an internal process stream.

Typically the auto-refrigeration can be done in one of two ways or a combination thereof:
Vaporization of the CO₂ rich bottoms liquid (8a, 8b) at lower pressure than the feed stream (typically 5 to 15 bar a) in up to four different steps; and/or
Turbine expansion of one or more of the product streams 5a and 5b.

Such a process presents the advantage of high efficiency (minimal compression and no heat or cold input required), high recovery (through membrane permeation and recycle), high pressure (>5 bar abs) recovery of the CO₂ and also an ability to produce high purity CO₂ (through distillation with a reboiler). The high purity of the CO₂ can be either a specification for the end-use or simply an economical optimum. For a minor cost increase the recovery of the valuable molecules (typically methane) is increased to near 100%.

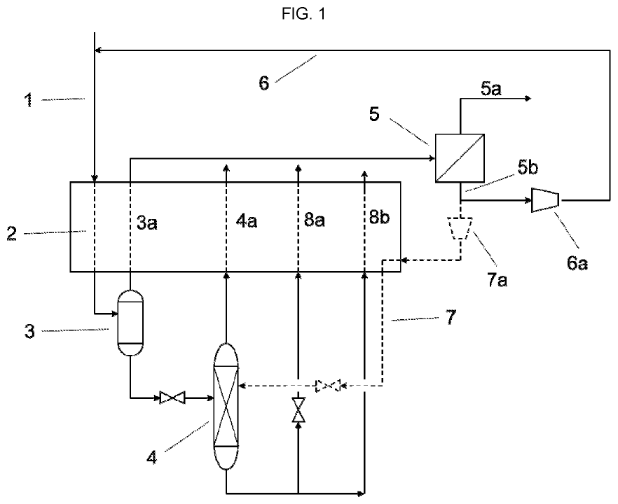

In one particular embodiment of the invention (second embodiment in FIG. 1), the permeate 5b from the membrane is recycled to the distillation column (4) directly (7) (without being mixed with the feed), and optionally without additional compression (7a) (typically permeate pressure is ˜10 bar abs). In such a case, the process is performed integrally without compression, except potentially product stream re-compression.

The inlet temperature of the membrane unit 5 is below −20° C. and preferably below ˜30° C., with increased selectivity and recovery compared to ambient temperature operation.

### INDUSTRIAL APPLICABILITY

The present invention is at least industrially applicable to removal and recovery of CO₂ from natural gas.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A method for treatment of a pressurized CO₂ rich natural gas stream comprising at least the following steps:
a) cooling the pressurized CO₂ rich natural gas stream to condense at least part of the CO₂ in a heat exchanger,
b) separating the majority of the CO₂ in the natural gas stream by partial condensation and distillation in order to obtain at least one non-condensable gas stream,
c) heating the non-condensable gas stream to a temperature lower than −20° C.,
d) introducing the non-condensable gas stream into a membrane permeation unit to separate the non-condensable gas stream into a residue stream enriched in methane and a permeate stream enriched in CO₂, compared to the non-condensable gas stream,
e) recycling the permeate stream to either the pressurized CO₂ rich natural gas stream prior to step a) and/or to the distillation of step b), and
f) wherein no external source of refrigeration provides cooling below 0° C. for any of steps a) to e) or any additional process steps performed between step a) and step e) (auto-refrigeration).

2. The method of claim 1 wherein the permeate stream is recycled directly to the distillation of step b).

3. The method of claim 2 wherein the permeate stream is recycled directly to the distillation of step b) without compression.

4. The method of claim 1 wherein an inlet temperature of the non-condensable gas stream feeding into the membrane permeation unit is below −30° C.

5. The method of claim 1 wherein a CO₂/methane selectivity of a membrane of the membrane permeation unit is at least twice the membrane selectivity at 20° C.

6. The method of claim 1, wherein the auto-refrigeration is provided by vaporization of a CO₂ enriched bottoms liquid from the distillation of step b), at lower pressure than the feed stream.

7. The method of claim 1, wherein the auto-refrigeration is provided by a turbine expansion of the permeate stream and/or the residue stream.

8. The method of claim 1 wherein the distillation in step b) includes a reboiling substep and the reboiling energy is provided by an internal stream of the method.

9. The method of claim 1, further comprising g) introducing the permeate stream into a second membrane separation unit to produce a second permeate stream and a second residue stream, and h) delivering the second residue stream as a fuel to a device powered, at least in part, by combustion of the second residue stream.
